(19) United States
(12) Patent Application Publication
(10) Pub. No.: US 2017/0345112 A1
(43) Pub. Date: Nov. 30, 2017

(54) Dynamic Threat Analysis Engine for Mobile Users

(71) Applicant: Tyco Fire & Security GmbH, 8212 Neuhausen am Rheinfall (CH)

(72) Inventors: Robert B. Locke, Sonoma, CA (US); Paul B. Rasband, Fremont, CA (US)

(21) Appl. No.: 15/600,846

(22) Filed: May 22, 2017

Related U.S. Application Data
(60) Provisional application No. 62/341,130, filed on May 25, 2016.

(51) Int. Cl. G06Q 50/26; G06Q 50/14; G06F 17/30

(52) U.S. Cl. CPC G06Q 50/265; G06F 17/30867; G06Q 50/14

(57) ABSTRACT

Techniques for detecting conditions at a geographic location are described. The techniques receive plural information feeds, aggregate the information according commonality of information, and analyze information from the plural information feeds according to rules. Upon detection of a rule being triggered for a particular user, the techniques produce or spawn an instruction thread that is controlled or scheduled by an instruction thread scheduler and which filters the received information from the data feeds according to the triggered rule, (and user, user location) and produce an instruction thread that continually analyzes the filtered information from the data feeds to produce operational decisions based on the information and data feeds, detect during the continual analysis changes in risk of a threat according to the triggered rule, produce response messages based on the determined change, and send the generated response messages as an alert to a system/device of a user.

### CLAIM OF PRIORITY

This application claims priority under 35 U.S.C. §119(e) to provisional U.S. Patent Application 62/341,130, filed on May 25, 2016, entitled: “Dynamic Threat Analysis Engine for Mobile Users,” the entire contents of which are hereby incorporated by reference.

### BACKGROUND

This description relates to data-driven threat analysis and advisory systems.

For many types of threats to the physical safety of people and infrastructure, location is a fundamental part of the threat analysis. For example, a hurricane may be approaching a particular city or province, or social media may suggest that rioting is about to break out in a particular part of a city.

### SUMMARY

While it is certainly true that threat advisory solutions currently exist, which take location into consideration, what is required are analytically solutions that integrate location and non-location based information to appraise potential threats faced by individuals in specific locations or traveling to specific locations, particularly in situations where the roles and responsibilities of those individuals are important considerations.

According to an aspect, a system includes a computing system, comprising one or more processors, memory and a computer readable hardware storage device storing a computer program product for detecting conditions at geographic locations, the computer program product comprising instructions to configure the computing system to receive a plural information feeds, aggregate the information according commonality of information and analyze information from the plural information feeds according to rules. Upon detection of a rule being triggered for a particular user, the system produces an instruction thread that filters the received information from the data feeds according to the triggered rule, produces an instruction thread that continually analyzes the filtered information from the data feeds to produce operational decisions based on the information and data feeds; and detects during the continual analysis changes in risk of a threat according to the triggered rule.

Aspects also include computer program products on non-transitory computer readable media and/or computer readable hardware storage devices and methods.

The aspects can include one or more of the following advantages.

The aspects execute a threat analysis engine for location specific reporting of threat conditions such as disturbances, weather-related threats as well as other types of threats to humans. A threat analysis engine receives information streams and makes a determination based on these multiple feeds threats to users according to a location that the user is currently in. In embodiments, the threat analysis engine is thread based and produces an open threat “ticket” (e.g., an open alert thread instance) for the user that is an execution of a sequence of program instructions that are managed independently by a thread scheduler. The thread continually monitors and analyzes the information feeds and multiple threads can be independently managed by the scheduler for like instances of a potential threat. These threads execute concurrently and share resources such as memory, executable code and values of variables and can spawn alerts that are sent to users.

The details of one or more embodiments of the invention are set forth in the accompanying drawings and the description below. Other features, objects, and advantages of the invention is apparent from the description and drawings, and from the claims.

### DESCRIPTION OF DRAWINGS

FIG. 1 is a block diagram of an exemplary Dynamic Threat Analysis (DTA) system.

FIG. 2 is a block diagram depicting aspects of the Dynamic Threat Analysis (DTA).

FIG. 3 is a flow diagram of Dynamic Threat Analysis (DTA) system processing.

FIG. 4 is a flow diagram of contingency planning within the Dynamic Threat Analysis (DTA) system processing.

FIG. 5 is a block diagram depicting a typical natural language processing arrangement.

### DETAILED DESCRIPTION

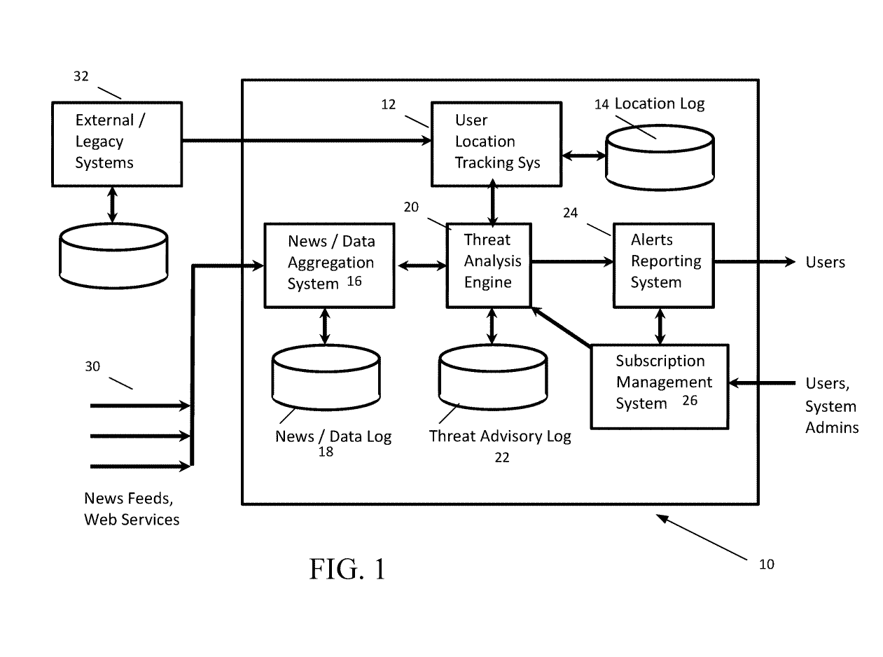

Referring now to FIG. 1, an exemplary embodiment of a Dynamic Threat Analysis (DTA) system 10 includes a user location tracking system 12, a user location log 14, a news/data feed collection and aggregation system 16, a news/data log 18, a threat analysis engine 20, a threat advisory log 22, an alerts/reporting system 24, and a subscription management system 26.

The DTA system 10 receives inputs, via the news/data feed collection and aggregation system 16. The news data feed collection and aggregation system 16 receives feeds (e.g., RSS (Really Simple Syndication protocol), podcast feeds and other content such as news streams 30. Feeds are asynchronously received and a history of loaded feeds is automatically saved. Feeds are in the form of datasets that are usually stored in as extensible markup language (XML). These feeds are often on web pages that have links to feeds often shown as orange “RSS”, “XML”, “Atom”, “Pod” icons on such pages. These feeds are delivered via web services from various sources such as news organizations, RSS feeds, weather service feeds, government posts, and proprietary data feeds that are on a subscription basis. Feeds from travel reservation systems, hotel booking systems, credit card service solutions, and cellular provider based software platforms are also collected.

The DTA system 10 receives information from legacy enterprise-level systems 32 such as a customer's time-and-attendance applications, time management solutions, e-mail services including e-mail and calendar information and similar software (not explicitly shown). Other information feeds can be used. The DTA system 10 accesses any external source that has an application programing interface (API), a web service or some other form of reporting or data query request/response capability.

External data feeds include a wide variety of data types from many sources. For example, there are currently websites such as “threatpost.com”, which are sources of RSS news feeds that cover security related topics related to civil unrest, cyberattacks, computer malware, and other threats. Websites such as “Cyveillance.com” is another raw news source and the airline industry and other groups collectively maintain “einnews.com” with many location-specific threat advisories. Other examples of sources of threat level data include governmental security oriented news feeds (for example, in the U.S., the State Dept. and DHS). Also, a number of tools have recently been introduced to allow global searches of blogs and social media posts for specific keywords. Examples include Technorati, PostRank, BoardReader, and Twitter Advanced Search. Some of these solution providers have machine readable interfaces.

The news/data feed collection and aggregation system 16 monitors a large, configurable set of news sources, perform semantic analysis on the raw data gathered (using standard natural language processing tools (NLP) to glean the context and “emotion” of words and phrases from text passages). The news/data feed collection and aggregation system 16 also maintains a database of words and phrases that are time/source/location-stamped and cross-referenced, and which are used by the threat analysis engine to perform a “deep” analysis. This database can be part of the log 18 or can be a separate structure accessible by the news/data feed collection and aggregation system 16.

In some implementations, the data feed collection and aggregation system 16 uses artificial intelligence to learn existence of new (not previously accessed) data sources from existing data sources. The data feed collection and aggregation system 16 samples various sources for relevant information. Sampling of sources is prioritized according to a record that is maintained by the data feed collection and aggregation system 16 that rates the efficacy of those sources and the data feed collection and aggregation system 16 conducts an evaluation of the value of such sources based on past performance. The data feed collection and aggregation system 16 determines which of the vast number of available sources provide fundamentally important and value-proven information. The data feed collection and aggregation system 16 classifies the sources according to that determination, and those sources with higher classifications would sampled more frequently in relation to newer or less effective or trustworthy sources. In some implementations web crawler software (i.e., web scrapers) are used for conventional news sites (e.g., web pages for large newspapers, Reuters, AP, etc.) to extract text that is filtered using the above mentioned NLP/semantic analysis tools.

The user location tracking system 12 may use a variety of technologies and may involve either involuntary or opt-in modes of user participation. For example, in one embodiment, users may use smart phones to “check in” periodically. In this opt-in situation, the user's location is not known to the system until they activate the application on their phone and turn on their phone's GPS tracking feature. In another case the smart phone may not use GPS at all, but may merely rely on input of location via a user interface on the smartphone at the time the user wishes to receive location-specific threat analysis information. In another embodiment the user may wear a special transponder designed to be tracked inside a wide-area network (e.g., a city's WiMax system), or a GPS enabled device specific to the solution. In yet another embodiment the user's location may be inferred from some transaction events and assumed from other information such as travel schedules. For example, if a corporate executive is scheduled to travel from home to another city on a certain day, and if back-end data systems such as travel reservation, airline, hotel, rental car, and credit card processing data systems all give transaction data consistent with the plans of the trip, then the location tracking system 12 of the current invention may logically conclude that the traveler's location is consistent with the travel itinerary. This user location information is stored in the location log 14.

In one implementation, the threat analysis engine 20 uses either formal rules or informal rules based on templates or patterns to determine when a threat exists. These rules are also used to determine a severity of the threat, a variation of the threat with respect to location and user profile (user characteristics), and an appropriate reporting language and reporting channel to report the treat to the user.

Formal rules can be predetermined. For instance, a formal rule could be, a threat rule for a list of users that are in current locations that may have threats. Such a formal rule could have a general form of (not intended as a programming statement):

```
<user list> <location> is <threat type>?
        <threat types> list
            <defined type analysis algorithms>
```

For an informal rules based implementation of the engine, threat analysis uses highly distributed and complex patterns, somewhat analogous to the way in which humans evaluate risk, i.e., (various instances of artificial intelligence) by comparing current facts and situations to past experience. In most cases the threat analysis engine 20 applies event identification and filtering technology, such that a rule set is a hybrid in between a simple (hard coded) rules engine on one extreme and full AI at the other extreme, e.g., a mix of such types of rules.

The alerts/reporting system 24 publishes alerts and sends security advisories to user system/devices (not shown) according to a determined reporting medium. In one embodiment all alerts for a given location are sent to everyone associated with the given location (say, due to their normal work location, residence location, or a special subscription to reports dealing with that location). In other embodiments the reporting system 24 may infer interest for a user for a given location based on a user's current location and anticipated future location(s) (as derived from data analyses on travel itineraries, group meeting schedules, and so forth). Interest may also be inferred by relationships among users. For example, a report may be sent to a user and the user's direct supervisor, or to a user and that user's legal guardian. The reporting may also be augmented by a directory or index from which a user may access reports specific to a location, threat type, and time period.

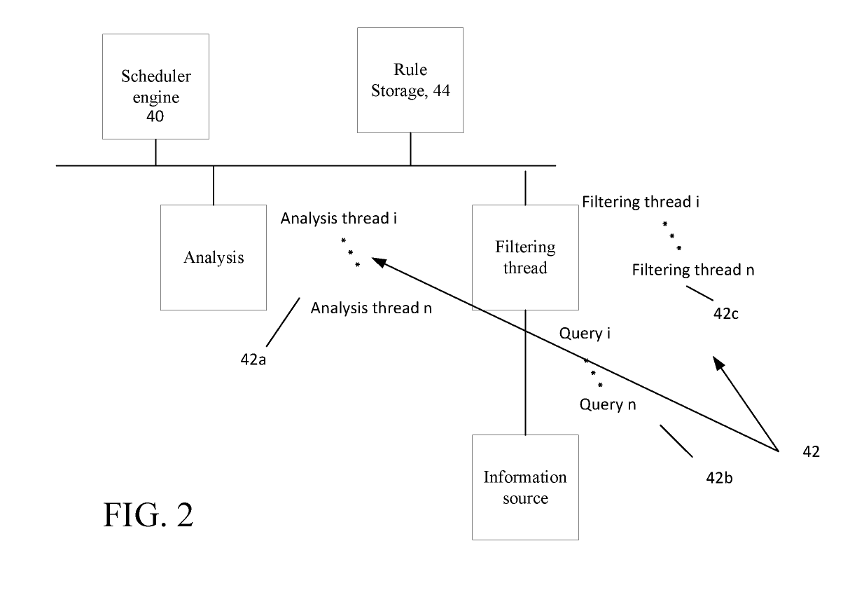

Referring to FIG. 2, a logical view of the DTA system 10 is shown including a scheduler engine 40 that schedules execution threads generally 42 including plural analysis threads 42a including analysis thread i to analysis thread n for plural users, plural filtering threads 42b including filtering thread i to filtering thread n for plural users, and plural query 42c threads including query thread i to query thread n for plural users. The scheduler engine 40 schedules these threads 42 for execution. The threads 42 are configured according to rules (obtained from rule storage 44) being executed on the DTA system 10. In the DTA system 10, the plural query threads 42b query information sources for information pertaining to a rule being evaluated for users i to n, the filter threads 42c filter that data for plural users and the plural analysis threads 42a analyze the filter data for each of users i to n according to the rule. The scheduler 40 schedules threads for execution according to various criteria such as detecting new, relevant information, time sequencing, threads executing bit waiting for data or other resources, etc.

The algorithms described below provide additional details on processers executed by the reporting engine.

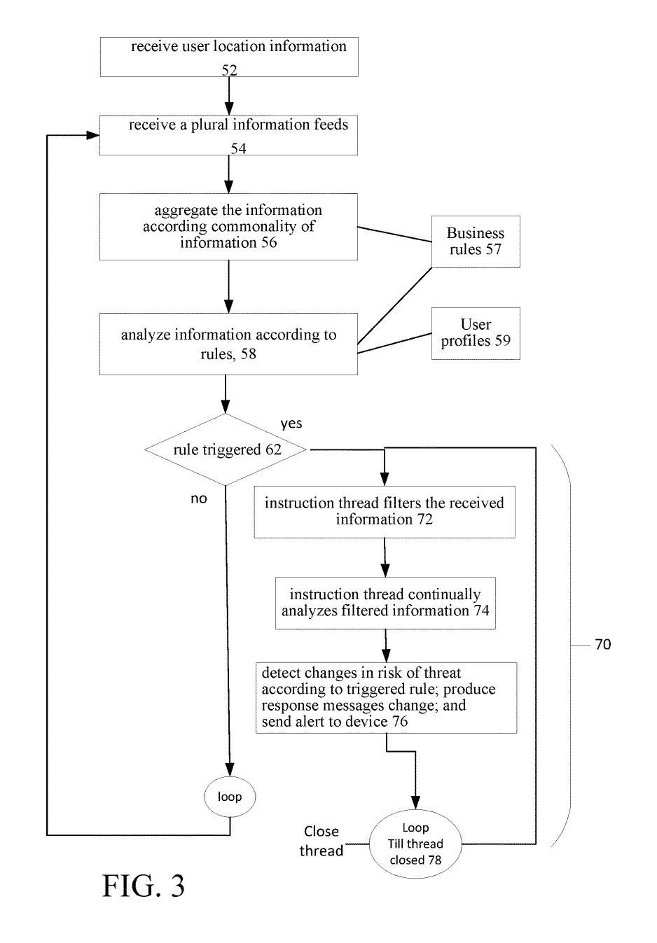

Referring to FIG. 3, threat analysis processing 50 executed in the threat analysis engine 20 is shown. The processing 50 can be extended to various rule scenarios and different processing is performed using the thread processing discussed above. For example, the threat analysis processing 59 will be described in relation to Location-Specific Reporting of Threats for Travelers. A rule that evaluations location-specific threats for travelers executes as a set of thread executions in the engine 30 of the DTA system 10. This rule involves monitoring of potential threat conditions in a given location.

A user, e.g., an employee of a company that subscribes to a DTA service 60 has installed on its device, e.g., a smartphone, a security advisory app (part of the interface to the alert reporting system described above).

Either automatically or through user interaction as discussed above, the DTA system 10 tracks 52 the user's location. The DTA system 10 periodically receives 54, e.g., samples information from various sources, especially sources with high trust levels for the particular location. The DTA system 10 aggregates 56 the received information according commonality of information among the sources. The DTA system 10 analyzes 58 the received aggregated information according to one or more likely plural rules (either formal rules or informal AI based business rules 57) and user profiles 59. The DTA system 10 either determines and/or directly receives information indicating the existence of a threat event, e. g., a terrorist attack in a city 30 miles from the city visited by the user, and the security app's threat analysis engine determines after analyzing the pool of data collected from news feeds that the chance of violence on foreign visitors in the user's location is unusually high (above a threshold danger metric value).

Based on the DTA system 10 determination and/or direct receipt of information indicating the existence of a threat event that has the user's location threat level as exceeding a threshold danger metric, the rule that was evaluated is triggered 62 for the particular user (or users). The location threat level from the engine 20 can be expressed in various forms. One form is a simple coded semantic value, e.g., high, moderate, low (any number of such levels could be used) another is a numeric value based on a calculated probability derived from prior history and experience based on various external estimates, e.g., governmental warnings, etc. or derived from past executions of the rule(s). A threshold danger metric can be established either algorithmically or empirically or present.

One approach to establishing a threshold danger metric, bases the threshold danger metric value on a previous threshold danger metric value. Any change in threat level determined for a current threat level in relation to the prior threat level triggers the rule (or if the threat level is reduced may provide a lower priority to execution of the rule), and that new threat level becomes the threshold danger metric. For example, for the form of a simple coded set of semantic values (very high, high, moderate, low very low), an initial threshold is set at moderate. The engine 20 determines that the threat level is, e.g., high. The engine sets the threshold now to high and increases the priority of those threads used to evaluate the corresponding rule. As some subsequent point in time the engine 20 determines that the threat level is now low. The engine sets the threshold now to low and decreases the priority of those threads used to evaluate the corresponding rule. Similar considerations would apply where the threat level and threshold is a numeric value based on a calculated probability.

Based the user's current location and the increased threat in that vicinity, the threat analysis engine 20 triggered the rule and the threat analysis engine 20 produces 70 an open threat “ticket” (e.g., an open alert thread instance) for the user. The open alert thread instance is an execution of a sequence of program instructions that are managed independently by a thread scheduler. The thread continually monitors and analyzes the information feeds as part of the DTA process. Multiple threads that are independently managed by the DTA scheduler are handled by the DTA process for like instances of a potential threat. These thread execute concurrently and sharing resources such as memory. In particular, the threads of the DTA process may share executable code and values of variables and spawn alerts that the DTA send to users including the user.

One particular implementation of the DTA process has the DTA system 10 analyzing information from the plural information feeds according to the rules discussed above. For example, for a formal written rule, upon detection by the DTA of the rule being triggered for the particular user, the DTA produces an instruction thread that accesses 72a received information and filters the received information from the data feeds according to parameters associated with the triggered rule. For example, these parameters could be location, reports of potential threats in the location etc. The DTA produces an instruction thread that continually analyzes 74 this filtered information from the data feeds to produce operational decisions based on the information and data feeds and the DTA detects 76 during the continual analysis any changes in a risk of a threat according to the triggered rule. Upon detection of changes the DTA either produces response messages either as alerts when the risk is elevated or modifies alerts when the risk is mitigated or removes the alerts and closes 78 the threads when the threat has passed or the user is no longer exposed to the potential threat. The DTA sends the generated response messages as an alert to a system/device of the user.

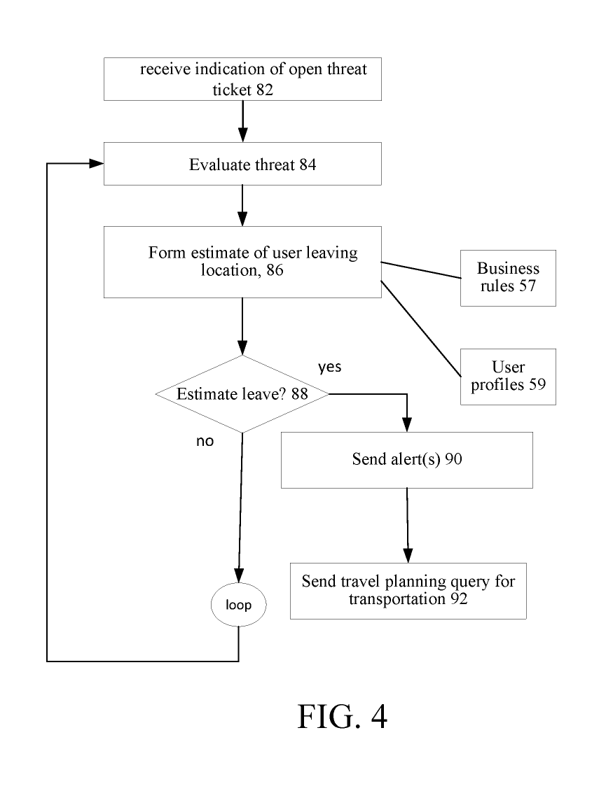

Referring now to FIG. 4, the analysis engine 20 can determine that a contingency plan thread should be executed. The analysis engine 20 forms a network of connections of information derived especially from sources that could impact contingency planning such as transportation providers. The analysis engine determines existence of conditions that could impact contingency planning (as well as improve or assist with the open alert thread analysis) receives indication of open threat ticket 82. Exemplary conditions include for e.g., airline travel variations or increases in last minute departures out of the city with high threat; limits on flights. The DTA 10 will evaluate the situation the threat 84 and form an estimate 86 based on the user's profile and the determined threat parameters of a reasonable probability that the user may wish to depart early.

Upon a determination 88 that the user should or would like to depart early, the analysis engine 20 sends 90 a high priority report to the user's e.g., a smartphone that is executing the security advisory app. The user receives the alerts and advises her travel agent to get her a seat on a plane as soon as possible. The DTA 10 can also inform other users associated with the user to inform those other users of the alert. The alert could also produce an estimate of the possibility that flights out of the area may become scarce within the next few hours. If there is no determination of the need for a contingency plan, i.e., the determination 88 is no, the process can loop or exit.

In another implementation, the DTA can also send 92 a travel planning query to a travel planning system that can search for and obtain travel options from an origin airport in or near the user's current location to a destination that is either a home destination, a subsequent stop in a pre-planned itinerary or merely a destination outside of the threat area.

Because the reporting system is configured to copy all of the user's alerts regarding travel plans to other predefined users that were pre-configured by the user to be copied on alerts sent to the user (e.g., by being contained in the user's profile), those other predefined users also receive the travel contingency report on their respective devices, e.g., smartphones and the like.

As long as the ticket (alert thread instance) remains open, the threat analysis engine 20 monitors all relevant back-end systems in the user's profile, including the company's travel system. When user's travel agent produces a new reservation for the user, the reporting system sends alert updates to the user and the other predetermined users. When user's location is detected or inferred to be in a location outside of the threat vicinity (e.g., when the flight to which she has checked in has taken off) a new alert is sent and the ticket is closed.

Location-Specific Reporting of Weather Related Threats

The DTA system 10 can have the threat analysis engine 20 configured for location specific reporting of weather-related threats. The processing described in FIG. 3, can be adapted to have the threat analysis engine 20 receive information streams from the News/Data Aggregation System, which stream includes weather related data and makes a determination based on these multiple feeds from weather forecasting services that a hurricane will possibly impact a zone about city in which the user is currently in. The user location tracking system 12 verifies the user's location as inside the zone of a likely impact area of the hurricane, and based on this analysis and updated weather forecasts the threat analysis engine 20 informs the reporting system 24 of an open threat ticket (alert thread instance). The threat analysis engine 20 produces this open threat “ticket” using a different thread instance of a different sequence of program instructions that are managed the thread scheduler (see FIG. 2). In this instance, the thread continually monitors and analyzes the information feeds as part of the DTA system 10 for weather related data and transportation options. The reporting system 24 sends a weather alert to the user as well as the other preconfigured users.

As above, the analysis engine 20 determines existence of conditions that could impact contingency planning (as well as improve or assist with the open alert thread analysis). Exemplary conditions for the contingency planning include for e.g., airline travel variations or increases in last minute departures out of the zone of the weather conditions, limits on flights, etc.

For example, as was mentioned in FIG. 4, similar processing can occur starting with the DTA system 10 opening a ticket 70 (FIG. 3), the contingency planning 80 receives 82 an indication of an open ticket by the DTA system 10. The contingency planning evaluates 84 the threat situation and forms an estimate based on the user's profile and the determined threat parameters of a reasonable probability that the user may wish to leave.

Upon a determination that the user should or would like to leave, the analysis engine sends 90 a high priority report to the user's e.g., a smartphone that is executing the security advisory app. The user receives the alerts and advises a travel agent to get a seat on a plane as soon as possible (or other mode of transportation, if so configured). The DTA system 10 inform other users associated with the user to inform those other users of the alert. The DTA system 10 sends 92 a travel planning query to a travel planning system that can search for and obtain travel options from an origin airport in or near the user's current location to a destination that is either a home destination, a subsequent stop in a pre-planned itinerary or merely a destination outside of the zone.

Should forecasts from weather services change and the threat analysis engine 20 notes the reduced threat, the closes the ticket, and sends a message to the reporting system that sends the threat reduction/ticket closure notice to the user and the predefined users.

Contingency Planning for Pools of Users:

A group of individuals from a company are planning a company trip to a common destination. As part of planning, a user sends a 3-month report request to the DTA for all travel and other interests related to the location. “Interests” are defined in the 3-month report subscription can include various items, such as tracking of any company employee or employee family member permanently or temporarily located inside the common destination; any employee/family member scheduled to travel to the common destination; anyone on an official event responsibilities list; and the direct supervisors for employees on that official event responsibilities list, etc. Prior to the trip a team of three from the events staff travels to the location to select vendors and other local staff.

The DTA system 10 scans the company's e-mail server, e.g., Outlook server for items that indicate that individuals on the team are “in common destination” for a period of time. During the period, the threat analysis engine analyzes data from several independent news feeds on social media chatter that labor riots are being planned with some level of certainty in the event city at the end of the week. The threat analysis engine consults the company's e-mail server (employee email/time management/calendar) application and notes that the above mentioned three individuals are currently listed “in the location.” (The user location tracking system 12 corroborates this for two of the individuals, but the tracking system lists the location of the third individual as “unknown—no recent update”.)

However, based on the company's e-mail server database status and the 3-month subscription request the threat analysis engine includes all three individuals in a report request to the reporting system. The reporting system issues text and email alerts on the riot advisory to the three individuals, their direct supervisors, and any other individuals listed as advisory recipients in the profiles of each of the three employees. The third employee also receives an alert that their location is not known and employee-originated location updates are requested.

Upon receipt of the alerts, the three employees decide after considering various plans to relocate to outside of the threat area. When they arrive at new location, the new location of the first two individuals is automatically updated by the tracking system and the location of the third individual is updated manually. With the three individuals outside the threat area the threat analysis engine instructs the reporting system to send a closed ticket alert to all individuals associated with the ticket (three employees, direct supervisors, and other profile-listed alert recipients).

Historical Analysis of Location-Specific Threats:

The DTA includes a subscription service maintained by subscription management system 26 that a user (or a third party on behalf of the user) subscribes to. The user would like to understand the threat environment in a plurality of different locations, e.g., for each of five locations. The service uses the analysis and reporting engines of the DTA system 10. The user submits a historical threat analysis request to the subscription management system. The subscription management system creates a historical threat analysis ticket request to send to the threat analysis engine, specifying the user as the report recipient. The threat analysis engine searches the threat advisory log and produces a threat profile for each of the five locations. Included in the threat profile are statistics and baseline comparisons in separate threat categories such as weather, violet crime, property crime, water and electricity service interruption, civil unrest, and terrorist activity.

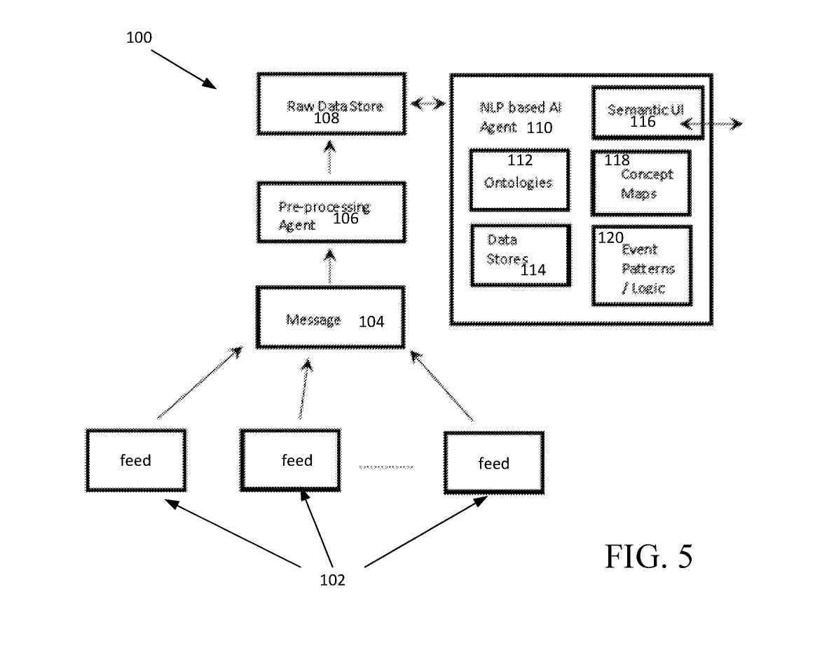

Referring now to FIG. 5, an exemplary NLP engine 100 (or natural language processing) is shown. The NLP engine 100 is fed information feeds 102 and having open-ended training of the NLP engine 100 by which the engine monitors various web-based information sources that deal with the above information. The engine 100 includes a message queue 104, a preprocessing agent 106, and raw data store 108. The engine 100 includes a NLP AI agent 110 that includes ontologies 112, especially to glean the emotion expressed in the information, data stores 114 and semantic user interfaces 116 as well as concept mapping 118 and event pattern mapping logic 120, which are generally known to those skilled in these arts. The NLP agent 110 may access news articles from websites and use these as resources forwarding data to the analysis engine 20. Also, the NLP agent 110 may include analogy based inference logic (known to those skilled in the art of creating AI agents) that is used by the NLP agent 110 to review news and autonomously hypothesize new rules (for later verification and sanction by human experts).

Much of the description of this embodiment has been simplified to avoid unnecessary complexity and confusion. For example, the simple message queue could use a distributed cloud-oriented message queue such as Kafka. The database could be a commercial version of a NoSQL database such as Cassandra or Mongo or Hadoop. The NLP agent 110 may in some embodiments have control over the behavior of the pre-processor agent 106. That is, the NLP agent 110 may decide what format data may take in the raw data store 108, so as to facilitate the use of the raw data store 108 by the NLP agent 110.

Not shown in the figure are the details of the reporting chain which the NLP agent may use to publish the occurrence of an alert. Also not shown in the figure is an embodiment where a special threat analysis engine or agent is interposed between the NLP agent and the raw data store. In this case, the threat analysis engine applies the rules used to recognize events. Otherwise (i.e., when the threat analysis engine is not present), this function is internal to the NLP agent.

Memory stores program instructions and data used by the processor of the intrusion detection panel. The memory may be a suitable combination of random access memory and read-only memory, and may host suitable program instructions (e.g. firmware or operating software), and configuration and operating data and may be organized as a file system or otherwise. The stored program instruction may include one or more authentication processes for authenticating one or more users. The program instructions stored in the memory of the panel may further store software components allowing network communications and establishment of connections to the data network. The software components may, for example, include an internet protocol (IP) stack, as well as driver components for the various interfaces. Other software components suitable for establishing a connection and communicating across network will be apparent to those of ordinary skill.

Program instructions stored in the memory, along with configuration data may control overall operation of the system. Servers include one or more processing devices (e.g., microprocessors), a network interface and a memory (all not illustrated). Servers may physically take the form of a rack mounted card and may be in communication with one or more operator terminals (not shown). An example monitoring server is a SURGARD™ SG-System III Virtual, or similar system.

The processor may include, or be in communication with, the memory that stores processor executable instructions controlling the overall operation of the monitoring server. Suitable software enables each monitoring server to receive alarms and cause appropriate actions to occur. Software may include a suitable Internet protocol (IP) stack and applications/clients.

Each monitoring server of the central monitoring station may be associated with an IP address and port(s) by which it communicates with the control panels and/or the user devices to handle alarm events, etc. The monitoring server address may be static, and thus always identify a particular one of monitoring server to the intrusion detection panels. Alternatively, dynamic addresses could be used, and associated with static domain names, resolved through a domain name service.

The network interface card interfaces with the network to receive incoming signals, and may for example take the form of an Ethernet network interface card (NIC). The servers may be computers, thin-clients, or the like, to which received data representative of an alarm event is passed for handling by human operators. The monitoring station may further include, or have access to, a subscriber database that includes a database under control of a database engine. The database may contain entries corresponding to the various subscriber devices/processes to panels like the panel that are serviced by the monitoring station.

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing the processes can be performed by one or more programmable processors executing one or more computer programs to perform the functions of the calibration process. All or part of the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Tangible, physical hardware storage devices that are suitable for embodying computer program instructions and data include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory.

In addition, the logic flows depicted in the figures do not require the particular order shown, or sequential order, to achieve desirable results. In addition, other actions may be provided, or actions may be eliminated, from the described flows, and other components may be added to, or removed from, the described systems. Likewise, actions depicted in the figures may be performed by different entities or consolidated.

Elements of different embodiments described herein may be combined to form other embodiments not specifically set forth above. Elements may be left out of the processes, computer programs, Web pages, etc. described herein without adversely affecting their operation. Furthermore, various separate elements may be combined into one or more individual elements to perform the functions described herein.

Other implementations not specifically described herein are also within the scope of the following claims.

What is claimed is:

1. A system comprises:
a computing system, comprising one or more processors, memory and a computer readable hardware storage device storing a computer program product for detecting conditions at geographic locations, the computer program product comprising instructions to configure the computing system to:
receive a plural information feeds;
aggregate the information according commonality of information;
analyze information from the plural information feeds according to rules, upon detection of a rule being triggered for a particular user,
produce an instruction thread that filters the received information from the data feeds according to the triggered rule;
produce an instruction thread that continually analyzes the filtered information from the data feeds to produce operational decisions based on the information and data feeds; and
detect during the continual analysis changes in risk of a threat according to the triggered rule.

2. The system of claim 1 wherein the computing system is further configured to:
collect information feeds from plural sources; and
execute one or more rules to continually analyze the information collected from the information feeds.

3. The system of claim 1 wherein the computing system further includes a thread scheduler that schedules execution of the instruction thread that filters the received information and the instruction thread that analyzes the filtered received information, and further comprises:
a query thread that sends queries to information sources for information pertaining to the rule being evaluated for the user.

4. The system of claim 1 wherein the computing system is further configured to:
detect changes in the information feed data;
compare detected changes to an initial analysis;
evaluate the changes with respect to the triggered rule; and
generate a list of most probable decisions according to triggered rule.

5. The system of claim 1 wherein the computing system is further configured to:
send a message to a user device, which includes embedded executable instructions to access an external system.

6. The system of claim 5 wherein the embedded executable instructions are a link to the external system that is a travel planning system.

7. The system of claim 1 wherein the instructions to produce response messages further comprise instructions to embed directive response instructions; and
send the generated response messages to a user device.

8. The system of claim 1 wherein a request to determine conditions at a location is received to initiate processing.

9. The system of claim 1 wherein the system is further configured to:
produce response messages based on the determined change; and
send the generated response messages as an alert to a system/device of a user.

10. The system of claim 1 wherein the rule is a formal rule that is triggered by a value exceeding a preset threshold value.

11. A computer program product tangibly stored on a computer readable hardware storage device, the computer program product for detecting conditions at a geographic location, the computer program product comprising instructions to cause a processor to:
receive a plural information feeds;
aggregate the information feeds according commonality of information;
analyze information from the plural information feeds according to rules, upon detection of a rule being triggered for a particular user,
produce an instruction thread that filters the received information from the data feeds according to the triggered rule;
produce an instruction thread that continually analyzes the filtered information from the data feeds to produce operational decisions based on the information and data feeds;
detect during the continual analysis changes in risk of a threat according to the triggered rule;
produce response messages based on the determined change; and
send the generated response messages as an alert to a system/device of a user.

12. The computer program product of claim 11 further comprising instructions to:
collect information feeds from plural sources; and
execute one or more rules to continually analyze the information collected from the information feeds.

13. The computer program product of claim 11 wherein the sensor data is collected continuously.

14. The computer program product of claim 11 wherein the instruction to execute include instructions to:
detect changes in the information feed data;
compare detected changes to an initial analysis;
evaluate the changes with respect to the triggered rule;
generate a list of most probable decisions according to triggered rule; and
produce messages having embedded executable instructions to access an external system as a link to the external system that is a travel planning system.

15. A method comprises:
receiving by one or more computing systems a plural information feeds;
aggregating by the computing system the information according commonality of information;
analyzing by the one or more computing systems the information from the plural information feeds according to rules, upon detection of a rule being triggered for a particular user,
producing by the one or more computing systems an instruction thread that filters the received information from the data feeds according to the triggered rule;
producing by the one or more computing systems an instruction thread that continually analyzes the filtered information from the data feeds to produce operational decisions based on the information and data feeds; and
detecting by the one or more computing systems during the continual analysis changes in risk of a threat according to the triggered rule.

16. The method of claim 15 further comprising:
detecting by the one or more computing systems changes in the information feed data;
comparing by the one or more computing systems detected changes to an initial analysis;
evaluating by the one or more computing systems the changes with respect to the triggered rule;
generating by the one or more computing systems a list of most probable decisions according to triggered rule; and
producing by the one or more computing systems messages having embedded executable instructions to access an external system as a link to the external system that is a travel planning system.
